(19) United States
(12) Patent Application Publication
(10) Pub. No.: US 2002/0052715 A1
(43) Pub. Date: May 2, 2002

(54) Maintenance management system for a production plant

(76) Inventor: Kari M. Maki, Jyvaskyla (FI)

Correspondence Address: LATHROP & CLARK LLP, 740 REGENT STREET SUITE 400, P.O. BOX 1507, MADISON, WI, 537011507

(21) Appl. No.: 09/966,424

(22) Filed: Sep. 28, 2001

Related U.S. Application Data
(63) Continuation of application No. PCT/FI00/00283, filed on Mar. 31, 2000.

(30) Foreign Application Priority Data
Mar. 31, 1999 (FI) 990715

(51) Int. Cl. G06F 15/00; G06F 11/30; G21C 17/00

(52) U.S. Cl. 702/184

(57) ABSTRACT

Information related to the manufacturing processes and machinery of a production plant (20) is collected by at least one information system, measurement unit, or production control unit (21, 22, 23, 24, 25), and sent (20) to a remote service unit (10), where it is collected and analyzed. The internal information network of the production plant (20) and the information network of the service unit (10) are isolated from the Internet by firewalls (F₁₀, F₂₀). The information is transferred bidirectionally via the firewalls (F₁₀, F₂₀) in a secured format. Information is transferred from Information systems (21, 22, 23, 24, 25) to a service system server (26). A service unit (10) has a data analysis unit (12) and a data bank (13). In the system there is established between the production plant (20) and the service unit (10) a secured communications connection.

### CROSS REFERENCES TO RELATED APPLICATIONS

This application is a continuation of PCT Application No. PCT/FI00/00283, filed Mar. 31, 2000, and claims priority on Finnish Application No. 990715, filed Mar. 31, 1999, the disclosures of both of which applications are incorporated by reference herein.

### STATEMENT AS TO RIGHTS TO INVENTIONS MADE UNDER FEDERALLY SPONSORED RESEARCH AND DEVELOPMENT

### BACKGROUND OF THE INVENTION

The invention relates to a maintenance management method and a system for a production plant.

The invention is related to the maintenance management of a production plant by virtue of bidirectional transfer of information between the production plant and a remotely located service unit responsible for service operations in order to provide information exchange for service and maintenance. In the present application, the term production plant is understood to refer to paper mills, board mills, pulp production plants, paper finishing plants and the like installations related to the manufacture/conversion of paper/board.

Conventionally, the servicing of paper/boardmaking machines and the like is based on separate machine analyses, condition tests and service packages, as well as service agreements based thereon, all of these aiming to minimize the occurrence of fault and disturbance factors in production plants. During malfunction situations, additional servicing operations are launched as necessary. The service unit may also perform continuous data logging on the condition of the production plant. This kind of information may be submitted from the production plant to the service unit in printed or electrical form, for instance.

In a more advanced format, information can be transferred between the production plant and the service unit using a so-called remote terminal connection such as that described in a magazine titled Kunnossapito (in English: Maintenance), Vol. 6/98. Via established remote terminal connection, the service unit can examine the views displayed on the paper-making machine information system in the same format as they are actually seen in the control room of the machinery. Typical target applications of a remote terminal connection are such as a process control and condition monitoring system. Over remote terminal connection, the personnel of the production plant can have a simultaneous telephone connection to the service personnel, which assists in providing an efficient and fast solution to problematic situations.

Although a remote terminal connection can improve the efficiency of service management, its technical implementation is complicated. To facilitate remote servicing, the service unit must have a separate user interface to each one of the monitored information systems. With the increasing complexity of automation in papermaking machines and the like, the number of installed measurement and information systems increases respectively, which imposes more demands to the performance level of a remote terminal connection. Moreover, different production plants have varied types of systems, which further complicates the operating environment.

As to the state of the art, reference is made to U.S. Pat. No. 5,844,601, wherein is described the communication between a production plant and a service center over audio and video connections. In this arrangement, the information gathering about the plant takes place by means of portable or fixed video cameras and earphone-microphone headsets that can be taken to desired areas around the plant. Within the plant area, video and audio signals are transmitted over an RF path to the regional service units and, therefrom, to the central service unit of the plant. From the base unit, the video and audio signals are transmitted to a remote service center using an ISDN connection or other communications facility.

In the transfer of information from a production unit to a service unit, the basic requirements are uncompromised confidentiality and data security. The service unit collects data and different key figures from a plurality of production plants, processes the data and returns each production plant feedback data and reference information. The data being gathered may be, e.g., production figures, fault and disturbance information, process values, paper web profiles, etc. When comparative reference data to be submitted back to the plants is processed, the names of the different production plants are eliminated from the produced data. The automation and maintenance systems of papermaking plants and the like also contain such data that is not desired to be submitted to the service unit. An example is the composition of paste. Frequently, the management system of a production plant contains information from a plurality of production lines, whereby it is necessary to border the access rights of a service unit to cover only the information related to the line concerned in the service contract activity.

### SUMMARY OF THE INVENTION

It is an object of the present invention to provide a novel method and system for information transfer between a production plant and a service unit so that the information to be transferred is transmitted in format secured against access by unauthorized parties.

It is a further object of the invention to provide a novel method and system capable of transferring data, audio and video signals for the purpose of enhanced service function.

It is another further object of the invention to provide a novel method and system offering flexible service scheduling.

It is still another further object of the invention to provide a novel method and system facilitating special measurements to be launched from the service unit in problem-solving situations, for instance.

In view of achieving the objectives stated above and those that will come out later the method according to the invention is mainly characterized in that the method comprises the steps of gathering information related to the manufacturing processes and machinery of a production plant by means of at least one information system and/or measurement unit and/or production control unit, connecting a service system server to the local information networks of the production plant(s), collecting information to the service system server from the different information systems of the production plant(s), sending the information from the production plant to a remote service unit, wherein the information submitted from at least one production plant is collected and analyzed, isolating the internal information network of the production plant from the Internet by a firewall, isolating the information network of the service unit from the Internet by a firewall, and transferring the information bidirectionally via the firewalls between the information network of the production plant and the information network of the service unit in a secured format.

The system according to the invention is characterized in that the system includes in the production plant information systems, wherefrom information is transferred to a service system server and further includes a service unit comprising a data analysis unit and a data bank, and in which system between said production plant and said service unit is established a secured communications connection comprising a firewall of said production plant, a firewall of the service unit and a secured communications connection therebetween.

In the method and system according to the invention, information is transferred between a production plant and a service unit via the Internet in a manner secured against access by unauthorized parties. The protection of data is implemented by means of the so-called firewall technique. A firewall serves to block unauthorized communication and enables authorized communication between a local information network and the Internet. Secured communications over the Internet can be assured, e.g., utilizing data transfer services offered by telecom network operators. With the help of a firewall and the data communications services, it is possible to establish a monitored gateway over which all communications over the interconnected networks take place. In the arrangement according to the invention, the firewall is located both between the information network of the service unit and the Internet and between the local information network of the production plant and the Internet. The communications channel connecting the service unit to the production plant is established between these firewalls. When necessary, a firewall may also be provided to protect a smaller subnetwork or unit. The authorized users of a protected network are identified at the firewall by their computer IP addresses. These protective measures are complemented with user ID codes and passwords.

Information transfer in the arrangement according to the invention takes place from the production plant's information systems either directly to a service unit or, alternatively, information in the production plant is gathered in a centralized manner to a service system server, wherefrom the data is transferred to the service unit.

The novel communications connection by virtue of the invention between a papermaking production plant or the like and a service providing unit facilitates a plurality of novel approaches to the implementation of maintenance and servicing activities. For instance, continuous data collection from the operation of a production plant gives enhanced possibilities of anticipating future needs of servicing. In certain situations, the scheduled maintenance periods may be extended when the units of machinery exhibit continuous operation without any signs of malfunction. Resultingly, the client can enjoy significant cost savings. Another situation may involve emerging malfunctions that may be anticipated and the service required thereby can be timed as preventive maintenance. These actions counteract long shutdowns of production due to fault situations and allow servicing and spare parts installations to be carried out before actual malfunction has occurred.

In the arrangement according to the invention, the information transmission draws upon the data transfer facilities offered by various telecom network operators for transferring data over the Internet, whereby substantially large amounts of information can be transmitted in a short time. Along with the transmission of numerical and textual data, it is also possible to transfer video and audio signals. These facilities are employed to support information gathering in a production plant particularly during a fault situation. The communications connection established in accordance with the invention also permits special measurements to be launched remotely from the service unit. Furthermore, it is possible to give the production plant's control room personnel recommendations on control of machinery over the communications connection established according to the invention.

In the following the invention will be described in detail with reference of the figures in the accompanying drawing, the invention being however by no means strictly confined to the details of said embodiments or variations.

### BRIEF DESCRIPTION OF THE DRAWINGS

FIG. 1 shows a diagram illustrating a maintenance arrangement according to the prior art.

FIG. 2 shows a diagram illustrating a maintenance arrangement according to the invention between a production plant and a service unit.

FIG. 3 shows a diagram illustrating a maintenance system having a single service unit connected to a plurality of production plants using a communications connection according to the invention.

### DESCRIPTION OF THE PREFERRED EMBODIMENTS

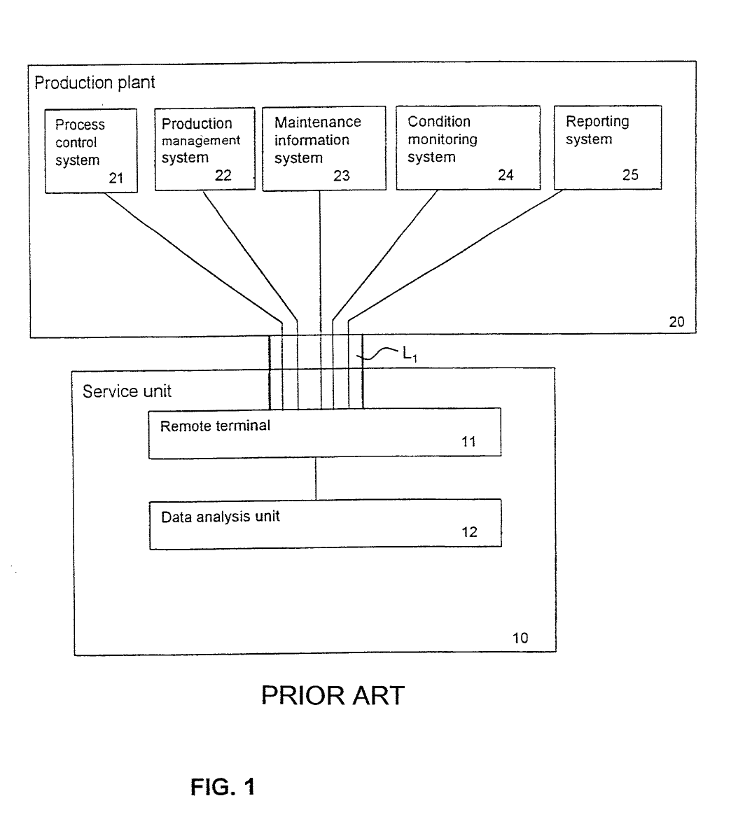

Referring to FIG. 1, therein is shown a prior-art scheme of maintenance system organization between a production plant 20 and a service unit 10. The production plant 20 may be a paper mill, board mill, pulp production plant, paper finishing plant or the like plant related to the manufacture/conversion of paper/board or some other kind of production plant.

The process performed in the production plant 20 comprise a highly automated process which is supervised and controlled via the internal information systems of the production plant 20. Such information systems include, e.g., a process control system 21, a production management system 22, a maintenance information system 23, a condition monitoring system 24 and a reporting system 25.

The service unit 10 is provided with a remote terminal connection to the information systems 21, 22, 23, 24, 25 of the production plant 20. From these information systems 21, 22, 23, 24, 25, the information is passed to a remote terminal unit 11 of the service unit 10 over a line L, that may be an ISDN connection, for instance. The remote terminal unit 11 contains a user interface for any one of the information systems 21, 22, 23, 24, 25 connected thereto, whereby the remote terminal unit 11 can be used for controlling these information systems in the same fashion as is done on site in the production plant 20. From the remote terminal unit 11, desired information can be transferred to a data analysis unit 12, wherein data obtained from the production plant 20 is analyzed and formed into a desired information format and reports to be utilized both by the service unit 10 and the production plant 20.

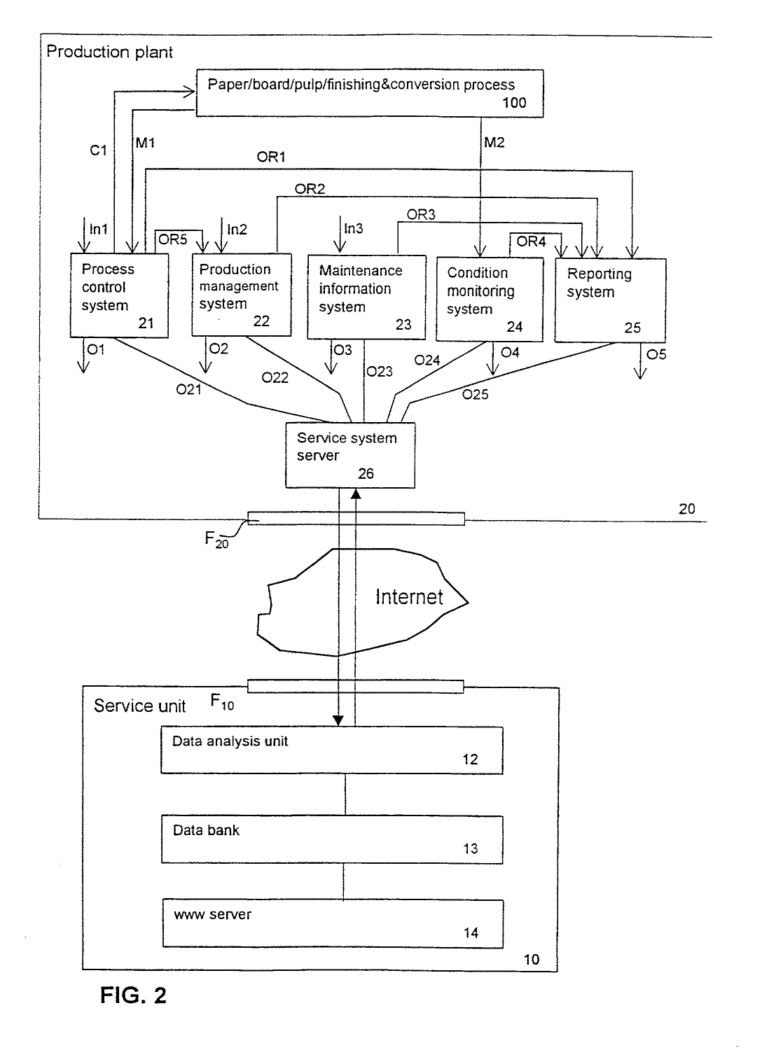

In FIG. 2 is shown an example of a maintenance arrangement in which a protected and secured communications connection is established between the production plant 20 and the service unit 10. Data O21, O22, O23, O24, O25 from the information systems 21, 22, 23, 24, 25 of the production plant 20 is gathered to a service system server 26 wherein the gathered data is treated and processed into a format essentially needed in servicing operations.

In the following, the operating principles and information transfer of the information systems 21, 22, 23, 24, 25 of the production plant 20 are described in more detail. The functions of a paper/board/pulp/finishing/conversion process 100 are controlled by a process control system 21. As input data In 1, the process control system 21 receives desired target values of such variables as product quality and raw material/chemicals consumption, among others. To the process control system, measurement data M1 is gathered from the process machinery 100 and, on the basis of the measurement data M1, takes place the process control C1. The input information ln2 of the production management system 22 comprises such data as specifications of ordered products and information OR5 is passed to it from the process control system 21, whereby the process control system 21 also receives information back from the production management system 22. The maintenance information system contains data on spare parts inventory, for instance. The function of the machinery condition monitoring system 24 is to log process parameters (M2) that are vital to the flawless function of the process including vibrations, circulating lubrication oil system, bearings, cleanliness of fabrics and other parameters of the process machinery 100. The process control system 21, the production management system 22, the maintenance information system 23 and the machinery condition monitoring system 24 submit information OR1, OR2, OR3, OR4 to the reporting system 25 that processes the received data into different types of reports O5 properly formatted chronologically, statistically and in other manners. Each subunit 21, 22, 23, 24, 25 of the information system may also be accessed separately for relevant information (O1, O2, O3, O4).

To the service system server 26 is collected only such data to which access is authorized by the client, that is, the production plant. In other words, not all the subsystems 21, 22, 23, 24, 25 of the information system and/or the information contained and/or produced by the subsystems 21, 22, 23, 24, 25 need necessarily be accessible by the service system server 26. Hence, information transfer between the subsystems 21, 22, 23, 24, 25 and the service system server 26 may be arranged to occur in a selective manner and to a predetermined extent. For instance, information transfer may take place only from the maintenance information system 23, whereby the data on the need for spare parts, as well as on the availability of spare parts, are accessible to both of the parties, or, alternatively, from the process control system 21, whereby control of the process may be carried out from the remotely located service unit 10. The service system server 26 provides a standard interface for information transfer to the use of the service unit. The service system server 26 is integrated into the information network of the production plant 20 and is located within the confines of a firewall F₂₀ of said local information network of the production plant 20.

From the service system server 26, the information is transferred via the firewall F₂₀ into the Internet utilizing, e.g., commercially available data transfer facilities (DataNet, LanLink), and therefrom further to the service unit 10. Thus, a secured connection is established by means of such data transfer facilities between firewalls F₁₀ and F₂₀. Data security is assured by identification of the IP addresses of the communicating computers and through the use of passwords and other authorization methods such as data transmission encryption. The thus formed communications connection over the Internet gives a possibility of transferring large amounts of information with high data security. The information may contain, e.g., data, video and/or audio signals.

The information transferred from the production plant is processed in the data analysis unit 12 of the service unit 10 and the analyzed data is stored in a data bank 13. From the service unit 10, the data is transferred back to the service system server 26 located at the production plant over the secured communications connection. Herein, the data transmission may be complemented with other type of information transfer such as video or voice transmission. Resultingly, effective tools are provided for processing fault information concerning a machinery malfunction situation and issuing instructions to the production plant 20. At the production plant 20, the information stored in the data bank 13 of the service unit 10 may be utilized by reading the stored data with the help of a www browser, for instance. However, each client is authorized to full access only to the data related to his own production plant, complemented with anonymous reference data collected from other production plants. Access to the information is locked behind the use of ID codes and passwords.

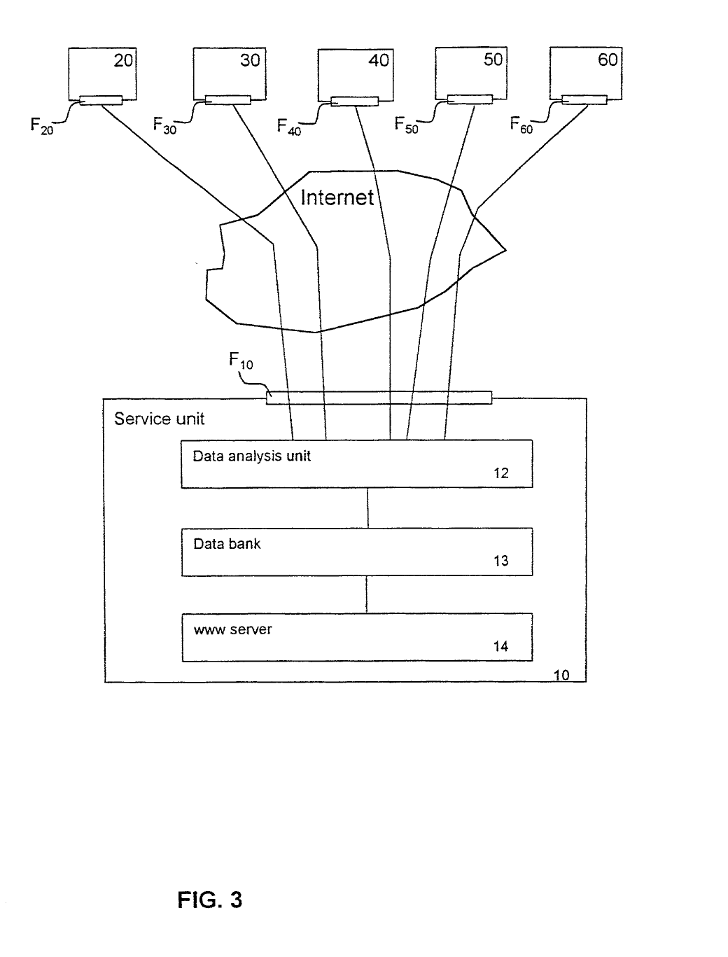

In FIG. 3 is shown a service unit 10 having by way of example a secured communications connection to a plurality of production plants 20, 30, 40, 50, 60. The communications connection from the service unit 10 to each one of the production plants 20, 30, 40, 50, 60 is established in accordance with the invention via a firewall F₁₀ of the service unit 10 to production plant 20 via its firewall F₂₀, to production plant 30 via its firewall F₃₀, to production plant 40 via its firewall F₄₀, to production plant 50 via its firewall F₅₀ and to production plant 60 via its firewall F₆₀. The number of production plants connected to the service unit 10 in accordance with the invention may obviously be varied substantially from that given herein by way of example.

The operation of the service unit 10 may be complemented with an expert group manned by specialists well skilled in the functions of the production plant 20. Obviously, the thus formed expert group can serve a plurality of client production mills and plants that may be located globally anywhere, whereby very quick responses to situations related to servicing and maintenance can be assured. This approach provides significant cost savings, since now not all malfunction situations need any more an expert to attend the plant site for solving a problem. On the other hand, the collected data may be utilized as prognostic information in the planning of service operations, whereby the preparations of the planned service call are carried out in a more efficient manner.

Moreover, the experts of the service unit 10 can also give assistance to the local service personnel of the production plants 20, 30, 40, 50, 60. The service unit 10 can initiate measurements in the production plant, perform remote diagnostics and give adjustment recommendations to the production plant personnel. Video and voice transmission over the communications connection assures efficient information transfer between production plant personnel and the service unit personnel.

In the above-described exemplifying embodiments, the production plant 20, 30, 40, 50, 60 may be, e.g., a paper mill, board mill, pulp production plant, paper finishing plant and the like installation related to the manufacture/conversion of paper/board or some other kind of production plant.

In the following the patent claims will be given and various details of the invention may show variation within the scope of the inventive idea defined in the patent claims and differ from the details disclosed above for the sake of example only.

I claim:

1. A method for arranging the maintenance of a production plant such as a paper mill, board mill, pulp production plant, paper finishing plant and the like installation related to the manufacture/conversion of paper/board, wherein the method comprises the steps of:
gathering information related to the manufacturing processes and machinery of a production plant by means of at least one information system and/or measurement unit and/or production control unit;
connecting a service system server to a local information network of the production plant;
collecting information to the service system server from different information systems of the production plant;
sending the collected information from the production plant to a remote service unit, wherein the information submitted from at least one production plant is collected and analyzed;
isolating the internal information network of the production plant from the Internet by a firewall;
isolating the information network of the service unit from the Internet by a firewall; and
transferring the information bidirectionally via the firewalls between the information network of the production plant and the information network of the service unit in a secured format.

2. The method of claim 1 wherein the service system server is located within the confines of a firewall of the local information network of the production plant.

3. The method of claim 1 wherein in the service system server the gathered data is treated and processed into a format essentially needed in servicing operations.

4. The method of claim 1 wherein authorized users in the service unit and the production plant are identified by the IP addresses of the computers between which the communications connection is to be established and/or by ID codes and/or passwords of the computer operators.

5. The method of claim 1 wherein the service unit is located geographically remote from the production plant.

6. The method of claim 1 wherein information is collected to the service unit from a plurality of production plants.

7. The method of claim 1 wherein the service system server sends information to the service unit in a standard format.

8. The method of claim 1 wherein information submitted from the production plant is analyzed in the service unit.

9. The method of claim 1 wherein operational recommendations are sent from the service unit to the production plant.

10. The method of claim 1 wherein information analyzed in the service unit is utilized for determining the timing of scheduled maintenance in the units of the production plant.

11. The method of claim 1 wherein data, video and/or audio signals are transferred between the production plant and the service unit.

12. A system for arranging the maintenance of a production plant related to the manufacture/conversion of paper/board, wherein the system includes in said production plant information systems, wherefrom information is transferred to a service system server and further includes a service unit comprising a data analysis unit and a data bank, and in which system between said production plant and said service unit is established a secured communications connection comprising a firewall of said production plant, a firewall of the service unit and a secured communications connection therebetween.

13. The system of claim 12 wherein the service system server is integrated into the information network of the production plant.

14. The system of claim 12 wherein the service system server is located within the confines of a firewall of said local information network of the production plant.

15. The system of claim 12 wherein the service system server is arranged to treat and process the gathered data into a format essentially needed in servicing operations.

16. The system of claim 12 wherein the service unit operates over a secured communications connection with at least one production plant, each said production plant being isolated from the Internet by a firewall.

17. The system of claim 12 wherein the service unit data analysis unit performs data processing and analysis, and wherein the data bank is connected to the data analysis unit for data storage.

18. The system of any claim 12 wherein the data bank of the service unit is provided with a www interface for browsing of information.

19. A method for servicing a production plant selected from the group consisting of a paper mill, a board mill, a pulp production plant, and a paper finishing plant; comprising the steps of:
gathering information related to manufacturing processes and machinery of the production plant by at least one information system, measurement unit, or production control unit;
connecting a service system server to a local information network of the production plant;
inputting said gathered information to the service system server;
sending said input gathered information from the production plant to a remote service unit, wherein the information submitted from the production plant is collected and analyzed;
isolating said local information network of the production plant from the Internet by a firewall;
isolating the information network of the service unit from the Internet by a firewall; and
transferring the information bidirectionally via the firewalls between the local information network of the production plant and the information network of the service unit in a secured format.
